(19) United States
(12) Patent Application Publication
(10) Pub. No.: US 2014/0086652 A1
(43) Pub. Date: Mar. 27, 2014

(54) FIXATION MEMBER AND FIXATION APPARATUS HAVING THE FIXATION MEMBER

(71) Applicants: NOK CORPORATION, Tokyo (JP); SYNZTEC CO., LTD., Tokyo (JP); NOK KLUEBER CO., LTD., Tokyo (JP)

(72) Inventors: Shingo SUGIYAMA, Kanagawa (JP); Masaya SUZUKI, Kanagawa (JP); Akira NISHIDA, Kanagawa (JP); Hitoshi OKABE, Kanagawa (JP); Tetsuhiro KITAHARA, Ibaraki (JP); Yujiro YAMASAKI, Ibaraki (JP)

(73) Assignees: NOK CORPORATION, Tokyo (JP); SYNZTEC CO., LTD., Tokyo (JP); NOK KLUEBER CO., LTD., Tokyo (JP)

(21) Appl. No.: 14/024,190

(22) Filed: Sep. 11, 2013

(30) Foreign Application Priority Data
Sep. 21, 2012 (JP) 2012-207949
Aug. 6, 2013 (JP) 2013-163439

(51) Int. Cl. G03G 15/20

(52) U.S. Cl. CPC G03G 15/2057
USPC 399/333

(57) ABSTRACT

The present invention provides a fixation member which exhibits enhanced wear resistance and sliding property between the peripheral surface of the fixation member and a pressure member, which can reduce driving torque at a fixation unit, and which does not cause stick slipping even in a high-load operational mode, and a fixation apparatus having the fixation member. The fixation member employed in a fixation unit of the fixation apparatus has a metallic substrate having at least one layer of an electrocast seamless belt, and a slide layer disposed on the inner peripheral surface of the metallic substrate, wherein the slide layer is formed of at least one species of the group consisting of a polyamide-imide resin and a polyimide resin, and a fluororesin; the slide layer has a fluororesin content of 27.5 mass % to 50 mass %; and the slide layer has a surface roughness Ra of 0.4 μm or less.

The entire disclosure of Japanese Patent Applications No. 2012-207949 filed on Sep. 21, 2012 and No. 2013-163439 filed on Aug. 6, 2013 is expressly incorporated by reference herein.

### BACKGROUND OF THE INVENTION

1. Field of the Invention

The present invention relates to an image-fixation member (hereinafter referred to simply as a “fixation member”) and an image-fixation apparatus (hereinafter referred to simply as a “fixation apparatus”) having the fixation member. More particularly, the invention relates to a fixation member and a fixation apparatus suitable for use in a fixing unit of an image-forming apparatus such as a copying machine, a facsimile machine, or a laser beam printer.

2. Background Art

A type of a fixation apparatus employed in an image-forming apparatus has an endless fixation belt (fixation member), a pressure roller disposed so as to face opposite the fixation member, and a pressure member that outwardly presses the fixation member against the opposite pressure roller, to thereby form a specific nip portion.

In such a fixation apparatus, the inner peripheral surface of the fixation member slides to the pressure member provided inside the fixation member, whereby both surfaces undergo wearing. Thus, typically, a lubricant such as silicone oil or fluorine-containing grease is caused to be present between the two surfaces, to thereby maintain wear resistance. However, even when such a lubricant is present, the sliding property between the inner peripheral surface of the fixation member and the pressure member decreases during a long-term operation or a high-load operation, to thereby problematically increase driving torque.

In order to prevent an increase in driving torque, an approach has been proposed. In this approach, a slide layer formed of a resin and a solid lubricant is disposed on the inner peripheral surface of the fixation member, to thereby enhance the wear resistance and sliding property between the inner peripheral surface of the fixation member and the pressure member (see Patent Documents 1 and 2).
Patent Document 1: Japanese Patent Application Laid-Open (kokai) No. 2004-286840
Patent Document 2: Japanese Patent Application Laid-Open (kokai) No. 2011-242731

However, even when such a slide layer is provided, in the case where the fixation apparatus is operated for a long time, particularly in a high-temperature, low-speed operational mode (e.g., in image fixation on a thick print medium such as an OHP sheet), the lubricant intervening between the inner peripheral surface of the fixation member and the pressure member is exposed to high temperature, so that the viscosity of the lubricant lowers, whereby squeezing out of the lubricant easily occurs. Once the lubricant is squeezed out, lubrication between the inner peripheral surface of the fixation member and the pressure member becomes poor, and stick slipping occurs. In this case, the slide layer problematically wears.

### SUMMARY OF THE INVENTION

In view of the foregoing, an object of the present invention is to provide a fixation member which exhibits enhanced wear resistance and sliding property between the inner peripheral surface of the fixation member and a pressure member provided inside the fixation member, which can reduce driving torque at a fixation unit, and which does not cause stick slipping even in a high-load operational mode. Another object is to provide a fixation apparatus having the fixation member.

In a first mode of the present invention for solving the aforementioned problem, there is provided a fixation member, for use in a fixation unit of a fixation apparatus, the fixation member comprising a metallic substrate having at least one layer of an electrocast seamless belt, and a slide layer disposed on the inner peripheral surface of the metallic substrate, wherein the slide layer is formed of at least one species of the group consisting of a polyamide-imide resin and a polyimide resin, and a fluororesin; the slide layer has a fluororesin content of 27.5 mass % to 50 mass %; and the slide layer has a surface roughness Ra of 0.4 μm or less.

According to the first mode of the invention, the wear resistance and the sliding property between the inner peripheral surface of the fixation member and the pressure member can be enhanced. Thus, even when the fixation apparatus is operated in a high-load operational mode, the sliding property between the inner peripheral surface of the fixation member and the pressure member can be maintained. Therefore, the fixation member of the first mode can reduce the driving torque at a fixation unit and prevents stick slipping.

Said at least one species of the group consisting of a polyamide-imide resin and a polyimide resin is preferably a polyamide-imide resin.

When a polyamide-imide resin is used, the wear resistance and the sliding property between the inner peripheral surface of the fixation member and the pressure member can be further enhanced. Thus, even when the fixation apparatus is operated in a high-load operational mode, the fixation member can reduce the driving torque at a fixation unit and ensures prevention of stick slipping.

The fluororesin is preferably polytetrafluoroethylene.

When polytetrafluoroethylene is used, the wear resistance and the sliding property between the inner peripheral surface of the fixation member and the pressure member can be further enhanced. Thus, even when the fixation apparatus is operated in a high-load operational mode, the fixation member can reduce the driving torque at a fixation unit and ensures prevention of stick slipping.

In a second mode of the present invention, there is provided a fixation apparatus having the aforementioned fixation member.

According to the second mode of the present invention, the wear resistance and the sliding property between the inner peripheral surface of the fixation member and the pressure member can be enhanced. Thus, even when the fixation apparatus is operated in a high-load operational mode, the sliding property between the inner peripheral surface of the fixation member and the pressure member can be maintained. Therefore, the fixation apparatus of the present invention can reduce the driving torque at a fixation unit and prevents stick slipping.

According to the fixation member and the fixation apparatus having the fixation member of the present invention, the wear resistance and the sliding property between the inner peripheral surface of the fixation member and the pressure member provided inside the fixation member can be enhanced. Thus, even when the fixation apparatus is operated in a high-load operational mode such as a high-temperature, low-speed operational mode, the sliding property between the inner peripheral surface of the fixation member and the pressure member can be maintained. Therefore, the fixation member and the fixation apparatus of the present invention can reduce the driving torque at a fixation unit and prevents stick slipping.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1 is a schematic cross-section of a fixation belt according to Embodiment 1;

FIG. 2 is a schematic cross-section of a fixation apparatus according to Embodiment 1;

FIG. 3 is a schematic cross-section of a fixation apparatus according to Embodiment 2;

FIG. 4 is a schematic cross-section of a fixation apparatus according to Embodiment 3;

FIG. 5 is a graph showing the relationship between the polytetrafluoroethylene content of the slide layer and the driving torque; and

FIG. 6 is a graph showing the relationship between the surface roughness of the slide layer and the driving torque.

### DETAILED DESCRIPTION OF PREFERRED EMBODIMENTS

The present invention will next be described in detail with reference to embodiments.

### Embodiment 1

The fixation member according to the present invention is suitably employed in a fixation unit of an image-forming apparatus so as to fix an unfixed toner image onto a recording medium through heat and pressure at the fixation unit. In Embodiment 1, the fixation member is an endless fixation belt (an endless belt or an endless film).

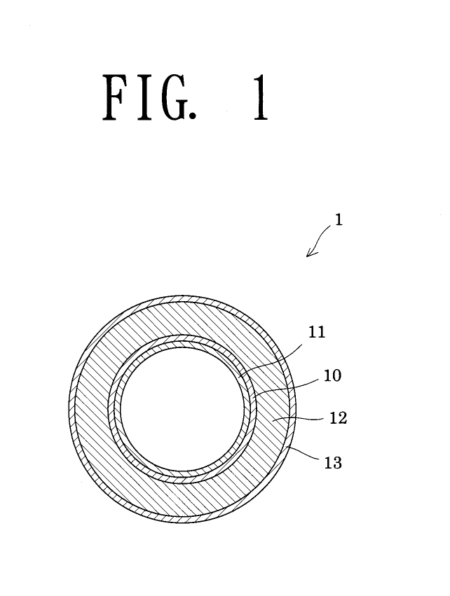

FIG. 1 is a schematic cross-section of a fixation belt 1. The fixation belt 1 has a metallic substrate 10 having at least one layer of an electrocast seamless belt, a slide layer 11 formed on the inner peripheral surface of the metallic substrate 10, an elastic layer 12 formed on the outer peripheral surface of the metallic substrate 10, and a release layer 13 formed on the outer peripheral surface of the elastic layer 12. That is, the slide layer 11, the metallic substrate 10, the elastic layer 12, and the release layer 13 are sequentially stacked from the inside.

The metallic substrate 10 has at least one layer of a nickel or nickel alloy electrocast seamless belt having excellent thermal conductivity and mechanical strength. The electrocast seamless belt may be formed of electrocast pure nickel or electrocast nickel alloy containing one or more elements of phosphorus, iron, cobalt, and manganese. Thus, the metallic substrate 10 employed in Embodiment 1 is formed of one layer of an electrocast nickel seamless belt. Needless to say, the metallic substrate 10 may have a plurality of electrocast seamless belts; for example, a tri-layer structure of nickel, copper, and nickel.

The metallic substrate 10 has a total thickness of, for example, 20 to 100 μm, preferably 25 to 60 μm. When the thickness is less than 20 μm, the strength of the entire substrate cannot be ensured, whereas when the thickness is in excess of 100 μm, bending stress increases, possibly causing a drop in durability. Thus, the metallic substrate 10 employed in Embodiment 1 is formed of an electrocast nickel seamless belt having a thickness of 40 μm.

The electrocast nickel or nickel alloy seamless belt may be generally formed through electrocasting by use of a nickel electrocasting bath; for example, a Watts bath containing as a predominant component nickel sulfate or nickel chloride, or a sulfamate bath containing as a predominant component nickel sulfamate, with a cylindrical substrate made of stainless steel, brass, aluminum, etc. In the case where the plating substrate is made of a non-conducting material such as silicone resin or gypsum, the non-conducting substrate is subjected to a conducting-property-imparting treatment by use of graphite or copper powder, or through silver mirror reaction, sputtering, or a similar process.

The nickel electrocasting bath is preferably a sulfamate bath. One exemplary composition of the sulfamate bath includes nickel sulfamate tetrahydrate (300 to 600 g/L), nickel chloride (0 to 30 g/L), boric acid (20 to 40 g/L), a surfactant (appropriate amount), and a brightener (appropriate amount). When a nickel electrocasting bath appropriately containing a water-soluble phosphorus-containing acid salt, a metal sulfamate salt (e.g., ferrous sulfamate, cobalt sulfamate, or manganese sulfamate), titanium potassium fluoride, or the like is employed, an electrocast seamless belt formed of a nickel alloy containing one or more elements of phosphorus, iron, cobalt, and manganese may be formed. Needless to say, such an electrocast seamless belt may be used as the metallic substrate 10.

The slide layer 11 is formed of at least one species of the group consisting of a polyamide-imide resin (PAI) and a polyimide resin (PI), and a fluororesin. Preferably, the slide layer has a fluororesin content of 27.5 mass % to 50 mass %, and has a surface roughness Ra of 0.4 μm or less.

The polyamide-imide resin and the polyimide resin have excellent heat resistance and wear resistance and are suitable for dispersion of fluororesin or the like therein. In Embodiment 1, a polyamide-imide resin is used.

Examples of the fluororesin include perfluoroalkoxyfluororesin (PFA), polytetrafluoroethylene (PTFE), tetrafluoroethylene-ethylene copolymer (ETFE), tetrafluoroethylene-hexafluoropropylene copolymer (FEP), poly(vinylidene fluoride) (PVDF), and chlorotrifluoroethylene-ethylene copolymer (ECTFE). Among them, polytetrafluoroethylene (PTFE) is preferred. In Embodiment 1, polytetrafluoroethylene is used.

The slide layer 11 preferably has a fluororesin content of 27.5 mass % to 50 mass %, more preferably 30 mass % to 40 mass %. Still more preferably, the slide layer 11 is made of a polyamide-imide resin and polytetrafluoroethylene, with the polytetrafluoroethylene content being 35 mass %.

The slide layer 11 preferably has a surface roughness Ra of 0.4 μm or less, more preferably 0.3 μm or less.

The surface roughness Ra (arithmetic mean surface roughness) refers to an average of absolute values of deviations (height or depth) from the center line. In Embodiment 1, Ra is determined in accordance with JIS B0601 (1994). Specifically, measurements of surface roughness Ra along the axial direction of the fixation belt 1 and the rotational direction thereof are averaged. The surface roughness Ra of the fixation belt 1 according to Embodiment 1 has substantially no variation, although measurement is performed at any sites of the fixation belt 1 in the axial direction and the rotational direction.

Next, the method of forming the slide layer 11 will be described.

Firstly, a fluororesin is dispersed in a solution of at least one species selected from the group consisting of a polyamide-imide resin and a polyimide resin, to thereby prepare a coating liquid.

Since it is used as a dispersion in the coating liquid, the fluororesin is preferably in the form of powder, or may be in the form of flakes or other forms. In Embodiment 1, polytetrafluoroethylene powder is used. For coloring the fixation belt 1, graphite or carbon black may be added to the coating liquid. However, such a colorant is used in such an amount that the surface roughness Ra of the slide layer 11 is not impaired. If the colorant is used, the amount thereof is about 10 mass % or less with respect to the slide layer 11.

Then, the thus-prepared coating liquid is applied to the inner peripheral surface of the metallic substrate 10, to thereby form a coating film. The film is then dried.

No particular limitation is imposed on the method of applying the prepared coating liquid, and the method of drying the coating film. In Embodiment 1, the coating liquid is applied by spraying, and the coating film is dried by means of a thermostat bath.

The surface roughness Ra of the slide layer 11 may be adjusted by modifying the time of coating application, coating amount, drying time, drying speed, etc. For example, surface roughness Ra can be reduced by application many times of thin layers or by drying the coating for a long period of time. In Embodiment 1, coating liquid is applied twice, and the formed film is dried at about 230° C. in a thermostat bath for about 30 minutes, whereby the surface roughness Ra of the slide layer 11 is adjusted to 0.4 μm or less.

The thickness of the slide layer 11 is, for example, 5 to 50 μm, preferably 5 to 30 μm. In Embodiment 1, the thickness of the slide layer is 13 μm. Through preliminarily heating of electrocast nickel alloy, or increasing the number of application operations or the number of repeating application of coating liquid and drying of coating film, a target thickness can be attained.

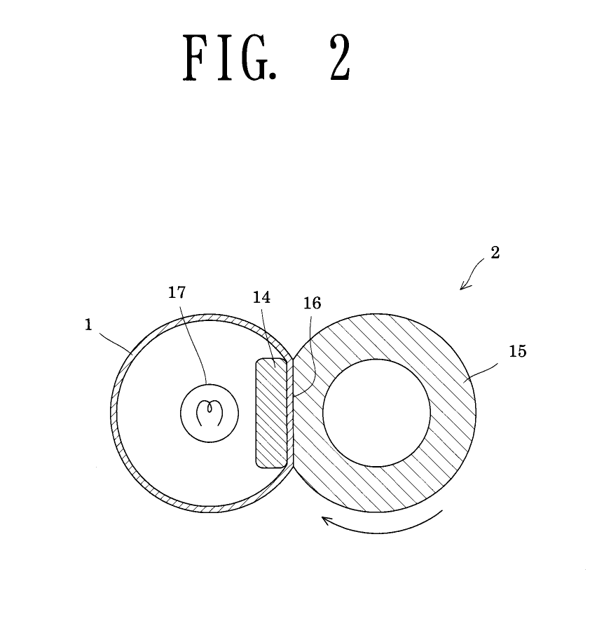

Through provision of the thus-formed slide layer 11 on the inner peripheral surface of the fixation belt 1, the wear resistance and the sliding property during sliding of the inner peripheral surface of the fixation belt 1 with a pressure member 14 provided inside the fixation belt 1 can be enhanced. The feature will be described in detail with reference to FIG. 2.

Through reducing the surface roughness Ra of the slide layer 11; specifically controlling to 0.4 μm or less, sliding property at the sliding face can be enhanced. In the case where a lubricant is present between the fixation belt 1 and the pressure member 14 (see FIG. 2), squeezing out of the lubricant is prevented, and favorable lube state can be maintained. Thus, stick slipping can be prevented.

However, even in the case where the surface roughness Ra is small; i.e., 0.4 μm or less, the driving torque at a fixation unit increases, when the amount of fluororesin contained in the slide layer 11 is excessively small. Thus, through controlling the fluororesin amount to fall within a specific range, friction coefficient can be reduced while wear resistance is maintained. As a result, driving torque can be reduced.

As described above, in order to enhance the wear resistance and the sliding property between the inner peripheral surface of the fixation belt 1 and the pressure member 14, reduce the driving torque at a fixation unit, and prevent stick slipping, the following are preferred. Firstly, the slide layer 11 is formed from at least one species selected from the group consisting of a polyamide-imide resin and a polyimide resin, and a fluororesin. Secondly, the fluororesin content of the slide layer is adjusted to 27.5 mass % to 50 mass %, and the surface roughness Ra of the slide layer 11 is adjusted to 0.4 μm or less.

Particularly when the fixation apparatus is operated in a high-temperature, low-speed operational mode (e.g., in image fixation on a thick print medium such as an OHP sheet), the lubricant intervening between the inner peripheral surface of the fixation belt 1 and the pressure member 14 is exposed high temperature, whereby squeezing out of the lubricant occurs, readily resulting in stick slipping. Even under such circumstances, through employment of the fixation belt 1 having the slide layer 11 according to the present invention, driving torque at the fixation unit can be reduced, and stick slipping can be prevented.

The elastic layer 12 is preferably formed of a material having high heat resistance. Examples of the material include silicone rubber, fluororubber, and urethane rubber. Of these, silicone rubber is particularly preferred. The thickness of the elastic layer 12 is, for example, 20 to 1,000 μm, preferably 50 to 500 μm. The elastic layer employed in Embodiment 1 is formed of a silicone rubber and has a thickness of 100 μm. Through provision of the elastic layer 12, flexibility of the fixation belt 1, and heat efficiency to the fixation unit can be enhanced, whereby fixability of an unfixed toner image to a recording medium can be enhanced, to thereby realize high-quality images. Notably, provision of the elastic layer 12 is optional.

The release layer 13 is preferably formed of a synthetic resin material having high releasability. An example thereof is a fluororesin. Examples of the fluororesin include perfluoroalkoxyfluororesin (PFA), tetrafluoroethylene-hexafluoropropylene copolymer (FEP), and tetrafluoroethylene-ethylene copolymer (ETFE). Among them, perfluoroalkoxyfluororesin (PFA) is preferred. The thickness of the release layer is, for example, 1 to 150 preferably 5 to 30 μm. In Embodiment 1, a tube having a thickness of 10 μm and formed of perfluoroalkoxyfluororesin (PFA) is employed.

Although not illustrated, the release layer 13 is attached to the outer peripheral surface of the elastic layer 12 by the mediation of an adhesive.

Next, the fixation apparatus according to the present invention will be described.

A fixation apparatus 2, which is an embodiment of the present invention, is employed in an image-forming apparatus and fixes an unfixed toner image onto a recording medium through heat and pressure.

FIG. 2 is a schematic cross-section of a fixation apparatus according to Embodiment 1. As shown in FIG. 2, the fixation apparatus 2 has a fixation belt 1, a pressure roller 15 disposed so as to face opposite the fixation belt 1, and a pressure member 14 that outwardly presses the fixation belt 1 against the opposite pressure roller 15, to thereby form a specific nip portion 16. A heating means 17 for heating the fixation belt 1 to a predetermined temperature is disposed inside the fixation belt 1.

In the fixation apparatus 2, the inner peripheral surface of the fixation belt 1 slides with the pressure member 14. Generally, a lubricant such as silicone oil, fluorine-containing oil, or fluorine-containing grease is caused to be present therebetween, to thereby maintain lubrication. In Embodiment 1, silicone oil intervenes therebetween (not illustrated).

The pressure member 14 is formed of an elastic material such as rubber. The elastic pressure member may be coated with an optional layer such as a fluororesin layer. In Embodiment 1, an elastic body coated with fluororesin fiber is employed as the pressure member 14. Alternatively, a slide sheet may be disposed on the elastic body. Preferably, the slide sheet or the like is formed of a resin having sliding property and heat resistance, such as a fluororesin or a polyimide resin. Also, in order to facilitate maintenance of the lubricant intervening between the fixation belt 1 and the pressure member 14, the surface of the slide sheet may be grooved or roughened.

The pressure roller 15 consists of a core made of metal or the like, and an elastic layer which is made of rubber or the like and which is formed on the peripheral surface of the core. From the viewpoint of reducing the heat capacity, the core is preferably hollow. However, a non-hollow shape may be accepted. The surface of the elastic layer may optionally be provided with a tube or a coating layer formed of a fluororesin such as PFA, or silicone rubber. In Embodiment 1, a silicone rubber layer having a thickness of 4 mm is employed as the elastic layer, and the elastic layer is coated with a PFA tube having a thickness of 50 μm.

Inside the fixation belt 1, the heating means 17 is disposed. No particular limitation is imposed on the heating means, so long as it can heat the fixation belt 1. The heating means may be disposed outside the fixation belt 1 or inside the pressure roller 15. Examples of the heating means include a halogen heater, a Nichrome heater, an infrared heater, and an electromagnetic induction heater with an exciting coil (heat source). In Embodiment 1, a halogen heater is employed.

The fixation apparatus has a fixation belt 1 that can enhance the wear resistance and the sliding property between the inner peripheral surface of the fixation belt 1 and the pressure member 14. Thus, even when the fixation apparatus is operated in a high-load operational mode (e.g., high temperature, low-speed), the driving torque at a fixation unit can be reduced, and stick slipping can be prevented.

### Embodiment 2

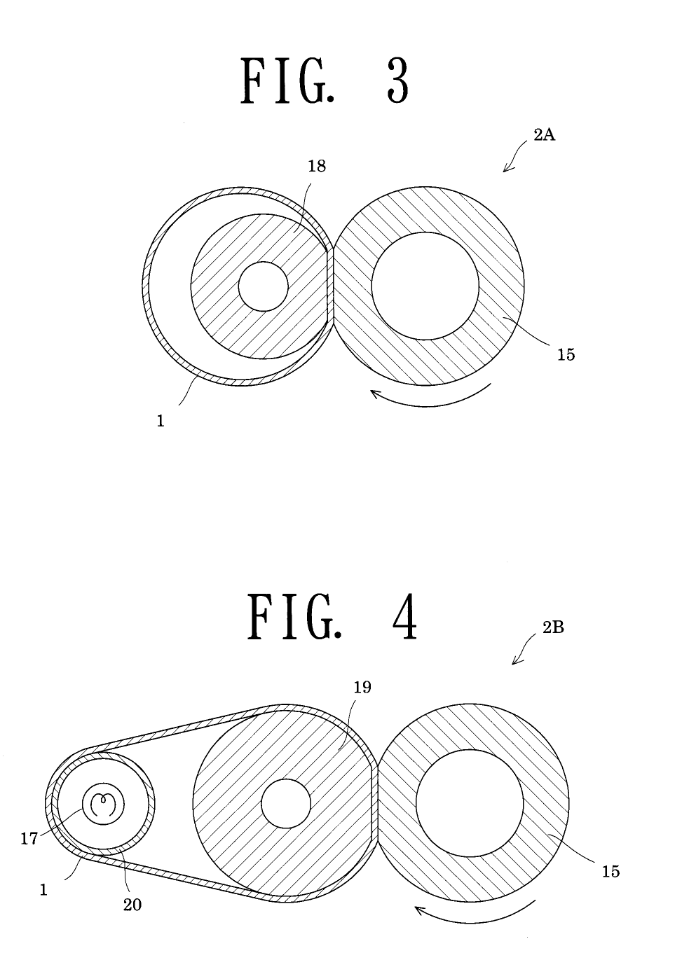

Embodiment 2 is a variation of the fixation apparatus. The same members as employed in Embodiment 1 are denoted by the same reference numerals, and overlapping descriptions will be omitted. FIG. 3 is a schematic cross-section of a fixation apparatus according to Embodiment 2.

As shown in FIG. 3, a fixation apparatus 2A has a fixation belt 1, a pressure roller 15 disposed so as to face opposite the fixation belt 1, and, instead of the pressure member 14, a fixation roller 18 that outwardly presses the fixation belt 1 against the pressure roller 15. A heating means for heating the fixation belt 1 may be disposed inside the fixation roller 18 or outside the fixation belt 1.

### Embodiment 3

Embodiment 3 is a variation of the fixation apparatus. The same members as employed in Embodiment 1 are denoted by the same reference numerals, and overlapping descriptions will be omitted. FIG. 4 is a schematic cross-section of a fixation apparatus according to Embodiment 3.

As shown in FIG. 4, a fixation apparatus 2B has a fixation belt 1, a pressure roller 15 disposed so as to face opposite the fixation belt 1, an inner roller 19 that outwardly presses the fixation belt 1 against the pressure roller 15, and a heating roller 20 inside which heating means 17 is disposed. In the fixation belt 1, the inner roller 19 and the heating roller 20 including the heating means 17 therein are disposed, whereby the fixation belt 1 is rotated by means of the inner roller 19 and the heating roller 20. In Embodiment 3, the heating means 17 for the heating roller 20 may be disposed outside the fixation belt 1.

### EXAMPLES

The present invention will next be described in detail by way of examples, which should not be construed as limiting the invention thereto.

### Example 1

Table 1 shows the materials for forming the slide layer 11 according to Examples 1 to 8 and Comparative Examples 1 to 7, and the results of surface roughness Ra measurement.

According to the aforementioned embodiments, the fixation belt 1 was produced in the following manner.

A phosphorus sulfamate electrocast bath of interest was prepared from nickel sulfamate (500 g/L), sodium phosphite (150 mg/L), boric acid (30 g/L), trisodium naphthalene-1,3,6-trisulfonate (1.0 g/L) serving as a primary brightener, and 2-butyne-1,4-diol (20 mg/L) serving as a secondary brightener.

While the electrocast bath was maintained at 60° C. and a pH of 4.5, electrocasting was performed with a stainless steel cylindrical substrate (outer diameter: 30 mm) as a cathode, and a depolarized nickel as an anode at a current density of 16 A/dm², to thereby deposit an electrocast film on the surface of the substrate. The thus-deposited film was extracted from the substrate, to thereby yield a metallic substrate made of electrocast nickel phosphorus alloy and having an inner diameter of 30 mm and a thickness of 40 μm. The metallic substrate was found to have a phosphorus content of 0.5 mass %.

Subsequently, the metallic substrate made of electrocast nickel phosphorus alloy is preliminarily heated at 60° C. Onto the thus-heated inner surface of the electrocast nickel phosphorus alloy substrate, a coating liquid (3 g) containing polyamide-imide (PAI) and polytetrafluoroethylene (PTFE) powder was sprayed twice. The PTFE content of the coating liquid was adjusted to 27.5 mass %. The thus-coated electrocast nickel phosphorus alloy substrate was dried at 100° C. in a thermostat bath for 30 minutes or longer, and the dried product was removed. The product was further fired at 230° C. for 30 minutes, whereby the slide layer 11 (inner coating film) formed of PAI and PTFE and having a thickness of 13 μm was formed on the inner peripheral surface of the fixation belt 1.

Then, a silane coupling agent was sprayed onto the outer surface of the electrocast nickel phosphorus alloy substrate and dried by means of a rotating shaft heater at 150° C. for 1 minute. Thereafter, a solvent-diluted silicone rubber (DY35-1114, product of Toray Industries, Inc.) was applied, and the applied silicone rubber was leveled by means of a rotating shaft heater at 70° C. for 5 minutes. The silicone rubber was subjected to primary curing at 150° C. for 1.5 minutes and 200° C. for 3 minutes, to thereby form the silicone rubber elastic layer 12 having a thickness of 100 μm.

Onto the silicon rubber layer, a primer was sprayed. The primer was dried at 100° C. for 3 minutes, and a PFA tuber was applied onto the primer.

Then, the resultant structure was placed in a thermostat bath at 70° C. The bath temperature was elevated from 70° C. to 300° C. over one hour, maintained at 300° C. for 20 minutes, and elevated again from 300° C. to 330° C. over 20 minutes. When the structure was removed from the bath, the release layer 13 formed of a PFA tube having a thickness of 10 μm was obtained.

In Example 1, the slide layer 11 was found to have a surface roughness Ra of 0.2 μm. In Example 1 and the below-described Examples 2 to 8 and Comparative Examples 1 to 7, the surface roughness of the slide layer obtained in each example was measured by means of a surface roughness meter (SURFCOM-1400A, product of Toyo Seiki Co., Ltd.).

The thickness of the slide layer (the thickness of the inner coating film) was measured by means of a micrometer in the following manner. Firstly, electrocast nickel phosphorus alloy having an inner coating film was removed from a fixation belt, and the thickness of the nickel phosphorus alloy having an inner coating film was measured. Then, the inner coating film is removed from the nickel phosphorus alloy having an inner coating film, and the thickness of the nickel phosphorus alloy was measured. The difference between the two thickness values was calculated by the following formula, to thereby determine the thickness of the slide layer.

(Thickness of electrocast Ni—P alloy having inner coating film)−(Thickness of electrocast Ni—P alloy)

When the fixation belt 1 produced according to Example 1 was placed in the fixation apparatus 2, silicone oil (0.5 g) was applied to the surface of the pressure member 14.

### Example 2

The procedure of Example 1 was repeated, except that the slide layer was formed by applying the coating liquid (3 g) through one spray coating step, to thereby form a fixation belt. The thus-formed slide layer was found to have a surface roughness Ra of 0.30 μm.

### Example 3

The procedure of Example 1 was repeated, except that the slide layer was formed by modifying the amount of PTFE contained in the coating liquid (3 g) to 35 mass %, to thereby form a fixation belt. The thus-formed slide layer was found to have a surface roughness Ra of 0.15 μm.

### Example 4

The procedure of Example 3 was repeated, except that the slide layer was formed by applying the coating liquid (3 g) through one spray coating step, to thereby form a fixation belt. The thus-formed slide layer was found to have a surface roughness Ra of 0.35 μm.

### Example 5

The procedure of Example 1 was repeated, except that the slide layer was formed by modifying the amount of PTFE contained in the coating liquid (3 g) to 50 mass %, to thereby form a fixation belt. The thus-formed slide layer was found to have a surface roughness Ra of 0.22 μm.

### Example 6

The procedure of Example 5 was repeated, except that the slide layer was formed by applying the coating liquid (3 g) through one spray coating step, to thereby form a fixation belt. The thus-formed slide layer was found to have a surface roughness Ra of 0.37 μm.

### Example 7

A fixation belt was formed in a manner similar to that employed in Example 1. The thus-formed slide layer was found to have a surface roughness Ra of 0.20 μm.

When the fixation belt 1 produced according to Example 7 was placed in the fixation apparatus 2, fluorine-containing grease (0.5 g) was applied to the surface of the pressure member 14.

### Example 8

The procedure of Example 1 was repeated, except that the slide layer was formed by modifying the amount of PTFE contained in the coating liquid (3 g) to 50 mass %, to thereby form a fixation belt. The thus-formed slide layer was found to have a surface roughness Ra of 0.22 μm.

When the fixation belt 1 produced according to Example 8 was placed in the fixation apparatus 2, fluorine-containing grease (0.5 g) was applied to the surface of the pressure member 14.

### Comparative Example 1

The procedure of Example 1 was repeated, except that the slide layer was formed by modifying the amount of PTFE contained in the coating liquid (3 g) to 25 mass %, to thereby form a fixation belt. The thus-formed slide layer was found to have a surface roughness Ra of 0.17 μm.

### Comparative Example 2

The procedure of Example 2 was repeated, except that the slide layer was formed by modifying the amount of PTFE contained in the coating liquid (3 g) to 25 mass %, to thereby form a fixation belt. The thus-formed slide layer was found to have a surface roughness Ra of 0.43 μm.

### Comparative Example 3

The procedure of Example 2 was repeated, except that the slide layer was formed with performing no preliminarily heating of electrocast nickel-phosphorus alloy and modifying the amount of PTFE contained in the coating liquid (3 g) to 25 mass %, to thereby form a fixation belt. The thus-formed slide layer was found to have a surface roughness Ra of 1.12 μm.

### Comparative Example 4

The procedure of Example 2 was repeated, except that the slide layer was formed by modifying the amount of PTFE contained in the coating liquid (3.5 g) to 35 mass %, to thereby form a fixation belt. The thus-formed slide layer was found to have a surface roughness Ra of 0.47 μm.

### Comparative Example 5

The procedure of Example 2 was repeated, except that the slide layer was formed with performing no preliminarily heating of electrocast nickel-phosphorus alloy and modifying the amount of PTFE contained in the coating liquid (3 g) to 50 mass %, to thereby form a fixation belt. The thus-formed slide layer was found to have a surface roughness Ra of 0.80 μm.

### Comparative Example 6

A fixation belt was formed in a manner similar to that employed in Comparative Example 1. The thus-formed slide layer was found to have a surface roughness Ra of 0.17 μm.

When the fixation belt 1 produced according to Comparative Example 6 was placed in the fixation apparatus 2, fluorine-containing grease (0.5 g) was applied to the surface of the pressure member 14.

### Comparative Example 7

A fixation belt was formed in a manner similar to that employed in Comparative Example 5. The thus-formed slide layer was found to have a surface roughness Ra of 0.80 μm.

When the fixation belt 1 produced according to Comparative Example 7 was placed in the fixation apparatus 2, fluorine-containing grease (0.5 g) was applied to the surface of the pressure member 14.

TABLE 1

| | Slide layer | | Surface | | | | |
|---|---|---|---|---|---|---|---|
| | composition | | roughness | | | | |
| | (mass %) | | Ra | | No. of | Thickness | |
| | PAI | PTFE | (μm) | Pre-heating | application | (μm) | Lubricant |
| Ex. 1 | 72.5 | 27.5 | 0.20 | yes | 2 | 13 | Silicone |
| | | | | | | | oil |
| Ex. 2 | 72.5 | 27.5 | 0.30 | yes | 1 | 13 | Silicone |
| | | | | | | | oil |
| Ex. 3 | 65 | 35 | 0.15 | yes | 2 | 13 | Silicone |
| | | | | | | | oil |
| Ex. 4 | 65 | 35 | 0.35 | yes | 1 | 13 | Silicone |
| | | | | | | | oil |
| Ex. 5 | 50 | 50 | 0.22 | yes | 2 | 13 | Silicone |
| | | | | | | | oil |
| Ex. 6 | 50 | 50 | 0.37 | yes | 1 | 13 | Silicone |
| | | | | | | | oil |
| Ex. 7 | 72.5 | 27.5 | 0.20 | yes | 2 | 13 | F grease |
| Ex. 8 | 50 | 50 | 0.22 | yes | 2 | 13 | F grease |
| Comp. | 75 | 25 | 0.17 | yes | 2 | 13 | Silicone |
| Ex. 1 | | | | | | | oil |
| Comp. | 75 | 25 | 0.43 | yes | 1 | 13 | Silicone |
| Ex. 2 | | | | | | | oil |
| Comp. | 75 | 25 | 1.12 | no | 1 | 13 | Silicone |
| Ex. 3 | | | | | | | oil |
| Comp. | 65 | 35 | 0.47 | yes | 1 | 17 | Silicone |
| Ex. 4 | | | | | | | oil |
| Comp. | 50 | 50 | 0.80 | no | 1 | 13 | Silicone |
| Ex. 5 | | | | | | | oil |
| Comp. | 75 | 25 | 0.17 | yes | 2 | 13 | F grease |
| Ex. 6 | | | | | | | |
| Comp. | 50 | 50 | 0.80 | no | 1 | 13 | F grease |
| Ex. 7 | | | | | | | |

### Test Example 1

Each of the fixation belts 1 produced in Examples 1 to 8 and Comparative Examples 1 to 7 was set in a fixation apparatus 2 shown in FIG. 2. Occurrence of stick slipping was checked, and driving torque was measured, through the following procedure.

A fixation belt deviation rectifying member was attached to each end of the fixation belt 1. The fixation belt 1, a heating means (halogen heater) 17, and a pressure member 14 were set in the fixation apparatus 2. A pressure roller 15 was pressed at a percent compression of 35%. The press depth was adjusted to 1.4 mm.

The fixation belt 1 had an inner diameter φ of 30 mm, and the pressure member 14 was coated with fluororesin fiber. The pressure roller 15 has an outer diameter φ of 30 mm and was clad with a PFA tube (the roller: Minicell (registered trademark)). The product “Minicell” is formed of a sponge material (rubber material) in which true spherical cells are uniformly dispersed (product of Synztec Co., Ltd.).

### Test for Checking Stick Slipping

Firstly, the fixation belt 1 was rotated at a linear velocity of 75 mm/sec in a load-free mode at ambient temperature for 5 minutes. Displacement of the surface of the fixation belt was measured by means of a non-contact displacement sensor (IL-100, product of Keyence corporation), and the output of the displacement sensor was input to a data logger (GR-7000, product of Keyence corporation). When vibration of a specific frequency was detected, the case was defined as occurrence of stick slipping.

Occurrence of stick slipping was checked at ambient temperature. Thereafter, while the linear velocity was maintained at 75 mm/sec, the surface temperature of the fixation belt 1 was elevated to 170° C. At 170° C., the fixation belt 1 was rotated in a load-free mode for 5 minutes, and stick slipping was checked at 170° C. Table 2 shows the results. In Table 2, occurrence of no stick slipping is denoted by “O,” and occurrence of stick slipping is denoted by “X.”

### Measurement of Driving Torque

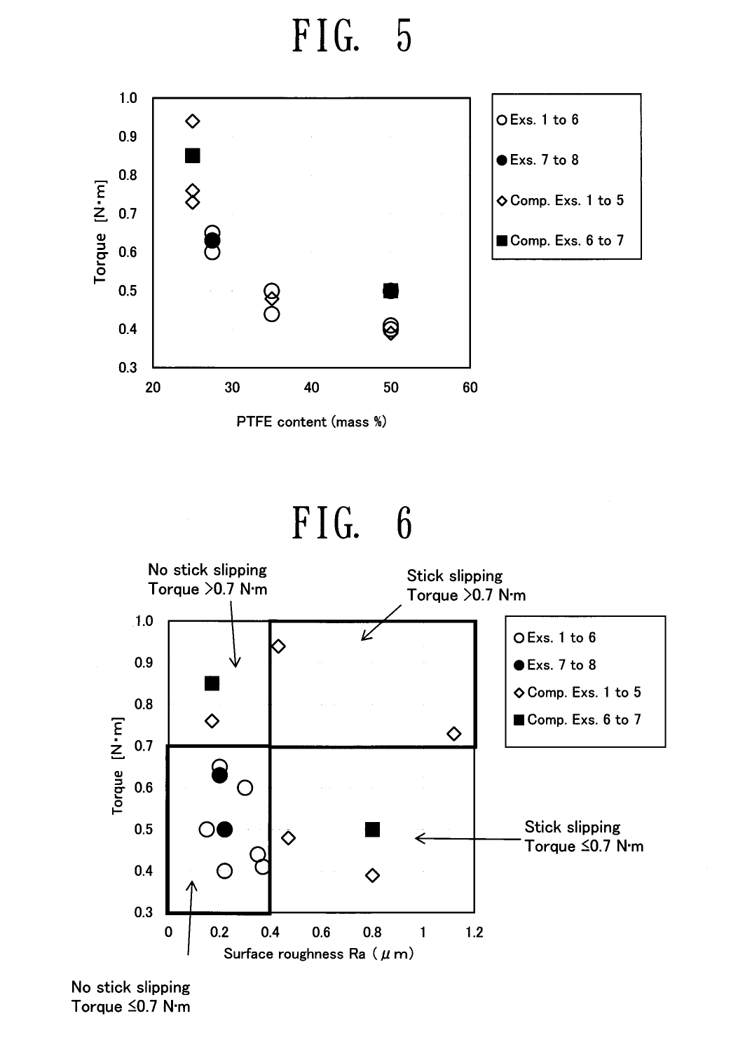

Similar to the case of the test for checking stick slipping, the surface temperature of the fixation belt 1 was elevated to 170° C. While the fixation belt 1 was rotated for 5 minutes in a load-free mode, driving torque was measured. In the case where the driving torque was lower than that attained by a conventional fixation machine; i.e., when the driving torque was 0.7 (N·m) or less, the case was evaluated as “low torque.” Table 2 shows the results. Also, FIG. 5 is a graph showing the relationship between the PTFE content of the slide layer and the driving torque, and FIG. 6 is a graph showing the relationship between the surface roughness of the slide layer and the driving torque.

TABLE 2

| | Stick slipping test | | Results |
|---|---|---|---|
| | (ambient and 170° C.) | Driving torque | Driving torque <0.7 |
| | No stick slipping: ◯ | Driving torque | and no stick slipping: |
| | Stick slipping: X | (N · m) | ◯◯, other cases: X |
| Ex. 1 | ◯ | 0.65 | ◯◯ |
| Ex. 2 | ◯ | 0.60 | ◯◯ |
| Ex. 3 | ◯ | 0.50 | ◯◯ |
| Ex. 4 | ◯ | 0.44 | ◯◯ |
| Ex. 5 | ◯ | 0.40 | ◯◯ |
| Ex. 6 | ◯ | 0.41 | ◯◯ |
| Ex. 7 | ◯ | 0.63 | ◯◯ |
| Ex. 8 | ◯ | 0.50 | ◯◯ |
| Comp. | ◯ | 0.76 | X |
| Ex. 1 | | | |
| Comp. | X | 0.94 | X |
| Ex. 2 | | | |
| Comp. | X | 0.73 | X |
| Ex. 3 | | | |
| Comp. | X | 0.48 | X |
| Ex. 4 | | | |
| Comp. | X | 0.39 | X |
| Ex. 5 | | | |
| Comp. | ◯ | 0.85 | X |
| Ex. 6 | | | |
| Comp. | X | 0.50 | X |
| Ex. 7 | | | |

### Results

As is clear from FIG. 5, when the PTFE content of the slide layer increased to about 50 mass %, driving torque decreased. As is clear from FIG. 6, the smaller the surface roughness of the slide layer, the lower the occurrence of stick slipping.

When the PTFE content was elevated to a suitable level; i.e., 27.5 mass % to 50 mass %, driving torque was able to be reduced. However, in view of the results of Comparative Examples 4, 5, and 7, when the surface roughness Ra was in excess of 0.4 μm, stick slipping occurred.

When the surface roughness Ra was adjusted to 0.4 μm or less, stick slipping was prevented. However, in view of the results of Comparative Examples 1 and 6, when the PTFE content was reduced to less than 27.5 mass %, driving torque increased.

Therefore, in order to realize both suppression of driving torque and prevention of stick slipping, the PTFE content of the slide layer in combination with the surface roughness Ra of the slide layer is preferably controlled to fall within a preferred range.

Through employment, in a fixation apparatus, of a fixation belt provided with a slide layer having such suitable characteristics, specifically, a slide layer of any of Examples 1 to 8, driving torque can be reduced, and stick slipping, which would otherwise be caused during driving, can be prevented.

Notably, in view of the results of Examples 1 and 7, Examples 5 and 8, Comparative Examples 1 and 6, and Comparative Examples 5 and 7, the type of lubricant (i.e., silicone oil or fluorine-containing grease) applied onto the top surface of the pressure member 14 was found to have no relation to driving torque or occurrence of stick slipping.

### Other Embodiments

Needless to say, the present invention is not limited to the aforementioned embodiment, and other embodiments may fall within the scope of the present invention. For example, as described above, the fixation member of the present invention is suitably employed as the aforementioned fixation belt, but may also be employed as a transfer/fixation belt or the like for fixation of as-transferred images. Thus, the mode of use of the fixation belt is not particularly limited. A fixation apparatus having the fixation member of the present invention may be used in various image-forming apparatuses such as a copying machine, a facsimile machine, a laser beam printer, other printers, and multi-function machines thereof.

What is claimed is:

1. A fixation member, for use in a fixation unit of a fixation apparatus,
the fixation member comprising a metallic substrate having at least one layer of an electrocast seamless belt, and a slide layer disposed on the inner peripheral surface of the metallic substrate, wherein:
the slide layer is formed of at least one species of the group consisting of a polyamide-imide resin and a polyimide resin, and a fluororesin;
the slide layer has a fluororesin content of 27.5 mass % to 50 mass %; and
the slide layer has a surface roughness Ra of 0.4 μm or less.

2. A fixation member according to claim 1, wherein said at least one species of the group consisting of a polyamide-imide resin and a polyimide resin is a polyamide-imide resin.

3. A fixation member according to claim 1, wherein the fluororesin is polytetrafluoroethylene.

4. A fixation member according to claim 2, wherein the fluororesin is polytetrafluoroethylene.

5. A fixation apparatus having a fixation member as recited in claim 1.

6. A fixation apparatus having a fixation member as recited in claim 2.

7. A fixation apparatus having a fixation member as recited in claim 3.

8. A fixation apparatus having a fixation member as recited in claim 4.
